(19) United States
(12) Patent Application Publication
(10) Pub. No.: US 2008/0079956 A1
(43) Pub. Date: Apr. 3, 2008

(54) Hand-Held Printer Having An Integrated Digital Camera Scanner

(76) Inventors: Mahesan Chelvayohan, Lexington, KY (US); John Thomas Writt, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/533,913

(22) Filed: Sep. 21, 2006

(51) Int. Cl. G06F 3/12

(52) U.S. Cl. 358/1.1

(57) ABSTRACT

A hand-held printer includes at least one print nozzle and a digital camera scanner. The digital camera scanner is operable to capture an image of an object, which is stored in a memory of the hand-held printer. The hand-held printer is then operable to print the captured image using the at least one print nozzle.

### FIELD OF THE INVENTION

The present invention relates generally to hand-held printers, and more particularly, to hand-held printing devices including an integrated digital camera scanner, and methods of using the same.

### BACKGROUND OF THE INVENTION

Portable computer printers are well known in the prior art and include dot-matrix printers, piezo-electric ink jet printers, laser printers and thermal ink jet printers. When using hand-held printers the printing surface is not fed through printer, but rather the hand-held printer is placed on a printing surface.

On many hand-held printers, printing is started and stopped through the depression of a “print” button. The printer head is first applied to the desired printing surface where the user wants printing to commence. The hand-held printer is generally aligned with the printing surface in a fashion so that the image may be linearly printed across the surface. The user next presses the button to initiate the printer head to begin printing the desired image onto the printing surface. This process continues for as long as the user depresses the print button or until an image to be printed is complete.

It will be appreciated that hand-held printers are adept at printing text and images stored on the hand held printer. Text and images may be transmitted to conventional hand-held printers wirelessly from a computer or via a wired connection such as a universal serial bus (USB). Hand-held printers may also receive a memory card or the like that stores an image or the like to be printed by the printer. Unfortunately, hand-held printers are unable to print images, text or the like without downloading the information from a memory card, computer or the like. This prevents hand-held printers from operating as a stand-alone device to capture the image of objects for subsequent printing.

### BRIEF SUMMARY OF THE INVENTION

According to an embodiment of the invention, there is disclosed a hand-held printer. The printer includes at least one print nozzle, and a digital camera scanner operable to capture an image of an object. The hand-held printer also includes at least one memory, operable to store the captured image of the objects and at least one print management module operable to instruct the handheld printer to print the captured image using the at least one print nozzle.

According to one aspect of the invention, the at least one print management module may be a processor, an application specific integrated chip, and/or computer-executable program code. The hand-held printer may also include an illuminator, such as an LED light source, operable to project light onto the object whose image is to be captured. According to another aspect of the invention, the digital camera scanner includes at least one lens and at least one imaging device, such as a charge-coupled device or a Complimentary Metal Oxide Semiconductor (CMOS) device. The at least one lens may be integrated into an underside or into a front side of the hand-held printer. Additionally, the hand-held printer can include a protective shield located adjacent the at least one lens. According to one aspect of the invention, the protective shield can be retractable.

According to yet another aspect of the invention, the hand-held printer can include a display screen operable to display the image of the object prior to capture of the image. The display screen can also display a rectangle that identifies the extent of the image to be captured by the digital camera scanner.

According to another embodiment of the invention, a method of printing is disclosed. The method includes capturing an image of an object using a digital camera scanner integrated into a hand-held printer, storing the captured image of the object, and instructing at least one print nozzle of the hand-held printer to eject ink to print the captured image.

According to one aspect of the invention, the step of instructing is executed by a processor, an application specific integrated chip, and/or a computer-executable program code. The method may also include illuminating the object using an illuminator, such as an LED, operable to project light onto the object during the capturing of the image of the object. The illuminator may be integrated into the hand-held printer. According to another aspect of the invention, capturing the image of the object includes capturing the image of the object using at least one lens and at least one imaging device. The at least one lens may be integrated into an underside or a front side of the hand-held printer.

According to yet another aspect of the invention, the method can include displaying the image of the object on a display screen of the hand-held printer prior to capturing the image. A rectangle may also be displayed on the display screen where the rectangle identifies the boundaries of the image to be captured by the digital camera scanner. According to another aspect of the invention, the distance of the hand-held printer from the object may be displayed on the display screen.

The method can also include projecting alignment marks onto at least one edge of the object, for instance, using an illuminator, which can be a light source. Alignment marks may also or alternatively be projected onto at least one corner of the object. According to another aspect of the invention the alignment marks can be turned off prior to capturing the image of the object.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 shows a perspective view of a hand-held printer, according to an illustrative embodiment of the present invention.

FIG. 2 shows a top view of a hand-held printer, according to an illustrative embodiment of the present invention.

FIG. 3a shows a partial side view of a hand-held printer, according to an illustrative embodiment of the present invention.

FIG. 3b shows an illustrative use of the hand-held printer of FIG. 3a, according to an embodiment of the present invention.

FIG. 4a shows a partial side view of a hand-held printer, according to another illustrative embodiment of the present invention.

FIG. 4b shows an illustrative use of the hand-held printer of FIG. 4a, according to an embodiment of the present invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

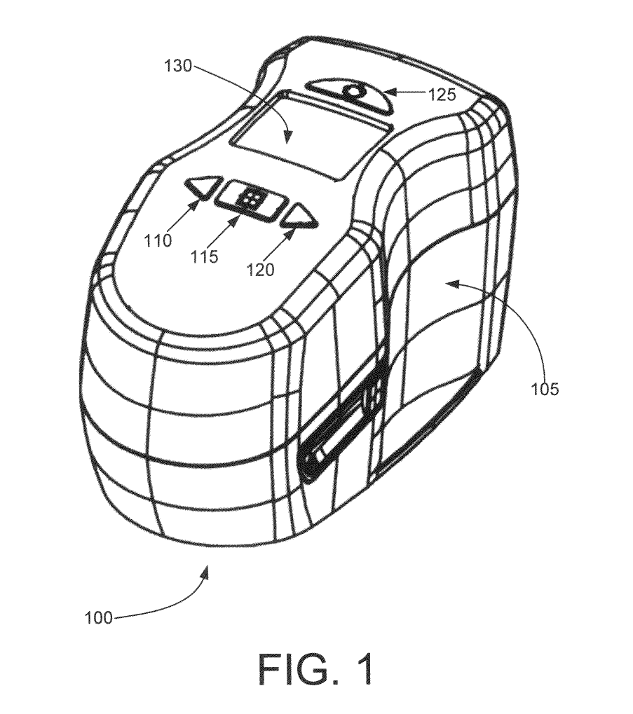

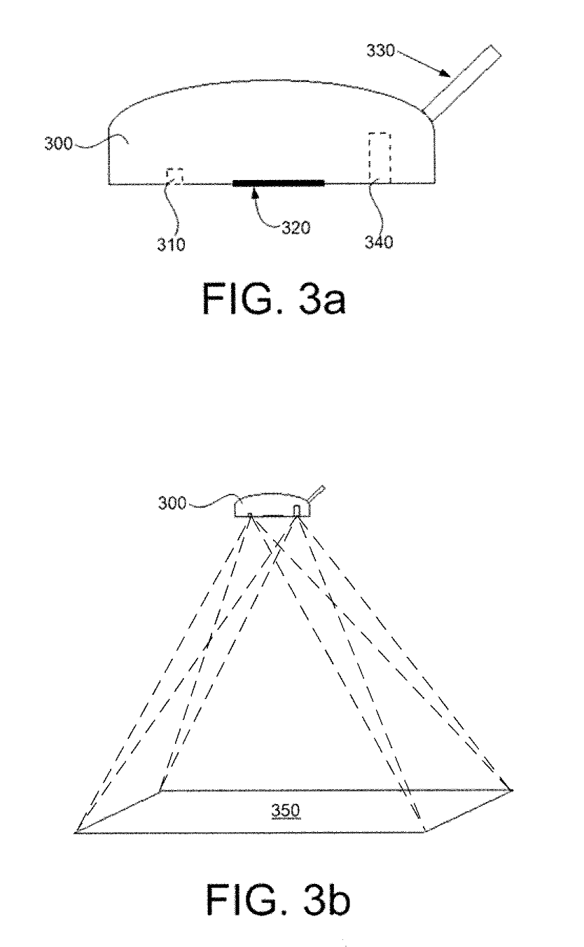

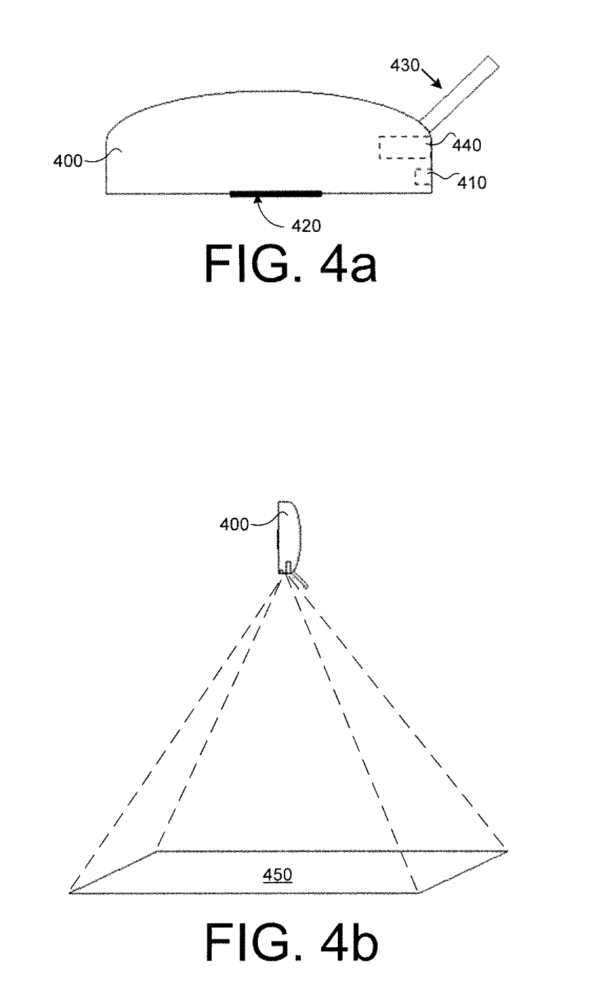

FIG. 1 shows a perspective view of a hand-held printer 100, according to an embodiment of the present invention. The hand-held printer 100 includes a digital camera scanner (not illustrated), which can include one or more one imaging devices, such as a charge-coupled device or a Complimentary Metal Oxide Semiconductor (CMOS) device and/or lenses, as are known in the art of digital cameras. The printer 100 can also include an illuminator (not illustrated) to illuminate a surface or object to be captured by the digital camera scanner. The digital camera scanner permits a user of the printer 100 to hold the printer 100 above an object, such as a page, to be scanned. An image of the object is then captured and stored in the hand-held printer 100, which can print the captured image to enable the printer 100 to function as a copier. The location and function of the digital camera scanner, including the one or more CCDs and/or lenses and the illuminator, will be described in greater detail with respect to FIGS. 3a-4b.

As shown in FIG. 1, the hand-held printer 100 includes a housing 105 for enclosing printer components, a display screen 130, such as an LCD screen, and one or more buttons 110, 115, 120, 125 for controlling the operation of hand-held printer 100. To print, the hand-held printer 100 also includes a printer head (not illustrated) that emits a marking substance, such as ink, onto a printing surface. Also included within the hand-held printer 100 is at least one internal tracking device (not illustrated) to identify the location of the hand-held printer 100, as is known in the art. The internal tracking device may include an optical mouse tracking device, or one or more rolling elements, to identify the current location of the hand-held printer 100, which may be in reference to an earlier location of the hand-held printer 100.

The hand-held printer 100 further includes one or more algorithms stored within a memory of the hand-held printer 100, which may be executed by the aid of a processor or like computing device to effect the printing processes described herein. Collectively the one or more algorithms and processor and or other hardware and software for executing capture of an image using the digital camera scanner and for executing print instructions are referred to as the print management module (not illustrated). The print management module may also or alternatively include an application specific integrated circuit (ASIC) or the like to effect the processes described herein. The print management module can receive instructions from the internal tracking device and utilize those instructions to determine when to instruct the printer head to print. It will be appreciated that the print management module may comprise one or more distributed components, such as ASICs, processors, memories, hardware, and the like to effect operation of the handheld printer 100.

According to one aspect of the invention, the one or more buttons 110, 115, 120, 125 are operative to enable a user to select and control one or more operations or functions of the hand-held printer 100. For instance, the buttons 110, 115, 120, 125 permit a user to select an image for printing, to print using the hand-held printer 100 The buttons also permit a user to capture an image using the digital camera scanner as described below with respect to FIGS. 3a-4b. According to one aspect of the invention, the one or more buttons 110, 115, 120, 125 may represent ‘soft’ buttons whose associated functions are displayed on the display 130. According to another aspect of the invention, the one or more buttons 110, 115, 120, 125 may be used to highlight and select functions displayed on the display 130. Although illustrated on a top side of the hand-held printer 100, it will be appreciated that the one or more buttons 110, 115, 120, 125 may be positioned anywhere on the housing 105 of the hand-held printer 100.

A user may initiate printing through the issuance of a command to the hand-held printer 110. Such a command may come from the pressing of one or more buttons 110, 115, 120, 125, which may trigger the print head to begin printing an image. In alternate embodiments, print commands may come by way of voice commands or optical impulses. The hand-held printer 100 may receive image data for printing from a number of sources. The image may be captured using the digital camera scanner, as described in detail below. The hand-held printer 100 may also or alternatively receive image data from a computer via a cable or wireless connection, such as via a USB cable or via Bluetooth®. The image data will be stored within a memory in the hand-held printer 100 for use in printing. According to another illustrative embodiment, a memory card containing image data, for instance, in an image file, may be inserted in to the hand-held printer 100 and act as the local memory of the printer.

As illustrated in FIG. 1, the hand-held printer 100 can also include a display screen 130. According to an aspect of the invention, the display screen 130 may be operable to display a representation of the amount of the currently printing image that has been printed at any given point in time. According to another aspect of the invention, the user can view the image to be printed on the LCD screen, or may view a file name associated with the image. The display screen 130 may also alert the user that an image has been completely printed by the hand-held printer 100.

According to an aspect of the invention, the display screen 130 can be used to ensure that the user properly positions the hand-held printer 100 to capture the image of an object using the digital camera scanner. The proper position may include the proper pitch, yaw and roll position of the printer 100 and the proper height of the printer 100 from an object, such as a page. In particular, proper height and positioning of the hand-held printer 100 relative to the object can be achieved by displaying a real-time image from the camera on the hand-held printer's display 130. The user can move the hand-held printer 100 until the image of the object to be scanned is clear and fills the screen or fills a temporary rectangle displayed on the display screen 130.

According to another embodiment of the invention, the hand-held printer 100 can include one or more LEDs or the like to project alignment marks onto a scan area, such as a rectangular border or corner points. This can provide feedback to a user to ensure proper positioning of the printer 100 The user can then position the hand-held printer 100 above the page in such a way that the projected border is at the edges of the page to be scanned, or the projected points are at the corners of the page to be scanned. The projected guides can be turned off the moment the page is read (scanned) to prevent those projections from being represented in the final image captured by the digital camera scanner.

It will be appreciated that the lens to object distance required for operation of the digital camera scanner may require that the digital camera scanner be placed from the object to be scanned by a certain distance. For instance, a minimum of approximately 8 inches from the lens to an object may be required for the digital camera scanner to capture a clear and crisp image that may be reprinted by the printer 100. According to one aspect of the invention, the height of the printer 100 from the object may be displayed on the display screen 130 to ensure that the proper focal distance is achieved.

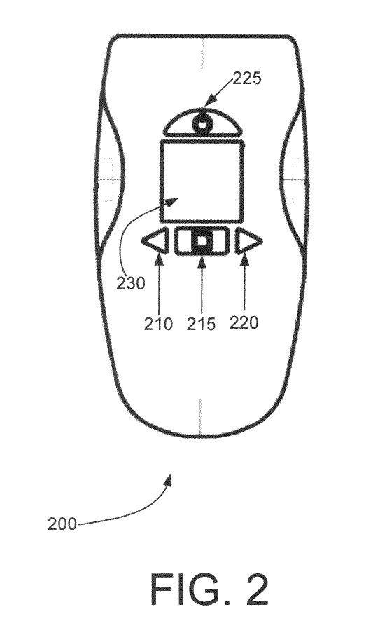

FIG. 2 shows a top view of a hand-held printer 200, according to an illustrative embodiment of the present invention. According to an aspect of the invention, the hand-held printer 200 includes a display 230 and one or more buttons 210, 215, 220, 225 that operate in a similar manner, respectively, as the display 130 and one or more buttons 110, 115, 120, 125 described above with respect to FIG. 1. Although not shown in FIG. 2, the hand-held printer 200 also includes a printer head that emits a marking substance, such as ink, onto a printing surface to print an image, and at least one internal tracking device (not illustrated) to identify the location of the hand-held printer 200, as is known in the art,

FIG. 3a shows a partial side view of a hand-held printer 300 similar to those described above with respect to FIGS. 1 and 2. The hand-held printer 300 includes a digital camera scanner 340 integrated into the underside of the hand-held printer 300, which may include one or more imaging devices and/or lenses, as are known to those of ordinary skill in the art of digital cameras. The hand-held printer 300 can also optionally include an illuminator 310 on the underside of the hand-held printer 300 to illuminate a surface or object to be captured by the digital camera scanner 340. Also illustrated in FIG. 3a is a side view of the print head 320 used by the printer 300 to effect printing, and a display screen 330 similar to the display screens 130, 230 described above with respect to FIGS. 1 and 2.

As shown in FIG. 3b, the digital camera scanner 340 permits a user of the printer 300 to hold the printer 300 above an object, such as a page 350, to capture an image of the object. Once the position of the hand-held printer 300 above the page 350 is satisfactory, as can be illustrated on the display screen 330, the user presses a button to scan the page 350. The illuminator 310, such as one or more white LEDs, illuminates the page 350 to be scanned for a proper light level. According to one aspect of the invention, the illuminator 310 can be turned on immediately before the scan is executed, or may stay on while the printer 300 is positioned. The image of the object is then captured by the digital camera scanner 340. Once the page 350 is scanned, the image is stored on the hand-held printer 300 and can be transferred to another system (e.g., PC hard drive) and/or can be printed by the hand-held printer on another sheet of media, essentially acting as a copier.

FIG. 4a shows a partial side view of a hand-held printer 400 similar to those described above with respect to FIGS. 1-3b. The hand-held printer 400 includes a digital camera scanner 440 integrated into the front side of the hand-held printer 400, which may include one or more imaging devices and/or lenses, as are known in the art of digital cameras. The hand-held printer 400 can also include an illuminator 410 on the front side of the hand-held printer 400 to illuminate a surface or object to be captured by the digital camera scanner 440. Also illustrated in FIG. 4a is a side view of the print head 420 used by the printer 400 to effect printing, and a display screen 430 similar to the display screens 130, 230 described above.

As shown in FIG. 4b, the digital camera scanner 440 permits a user of the printer 400 to hold the printer 400 above an object, such as a page 450, to capture an image of the object. Once the position of the hand-held printer 400 above the page 450 is satisfactory as can be illustrated on the display screen 430, the user presses a button to scan the page 450. The illuminator 410, such as one or more white LEDs, illuminates the page 450 to be scanned for a proper light level. According to one aspect of the invention, the illuminator 410 can be turned on just at the moment of scan or may stay on while the printer 400 is positioned. The image of the object is then captured by the digital camera scanner 440. Once the page 450 is scanned, the image is stored on the hand-held printer 400 and can be transferred to another system (e.g., PC hard drive) and/or can be printed by the hand-held printer on another sheet of media, essentially acting as a copier.

According to one aspect of the invention, permanent shields can be incorporated into hand-held printers of the present invention to reduce ink mist contamination of the digital camera scanner. A protective cap can also cover the lens of the digital camera scanner, such that the cap is easily removed by the user when a scan is to take place. Alternatively, a retractable shield can cover the lens, where the shield is temporarily retracted upon the pressing of a button (either a separate button from the scan button, or the same button) when a scan is to take place.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A hand-held printer, comprising:
at least one print nozzle;
a digital camera scanner, wherein the digital camera scanner is operable to capture an image of an object;
at least one memory, operable to store the captured image of the object; and at least one print management module operable to instruct the handheld printer to print the captured image using the at least one print nozzle.

2. The hand-held printer of claim 1, wherein the at least one print management module comprises at least one of a processor, an application specific integrated chip, and a computer-executable program code.

3. The hand-held printer of claim 1, wherein the hand-held printer further comprises an illuminator operable to project light onto the object.

4. The hand-held printer of claim 1, wherein the digital camera scanner comprises at least one lens and at least one imaging device.

5. The hand-held printer of claim 4, further comprising a protective shield located adjacent the at least one lens.

6. The hand-held printer of claim 5, wherein the protective shield is retractable.

7. The hand-held printer of claim 4, wherein the at least one lens is integrated into an underside of the hand-held printer.

8. The hand-held printer of claim 4, wherein the at least one lens is integrated into a front side of the hand-held printer.

9. The hand-held printer of claim 1, further comprising a display screen, wherein the display screen is operable to display the image of the object prior to capture of the image.

10. The hand-held printer of claim 9, wherein the display screen is operable to display a rectangle that identifies the image to be captured by the digital camera scanner.

11. A method of printing, comprising:
capturing an image of an object using a digital camera scanner integrated into a band-held printer;
storing the captured image of the object; and
instructing at least one print nozzle of the hand-held printer to eject ink to print the captured image.

12. The method of claim 11, wherein capturing the image of the object comprises capturing the image of the object using at least one lens and at least one imaging device.

13. The method of claim 12, wherein the at least one lens is integrated into an underside of the hand-held printer.

14. The method of claim 12, wherein the at least one lens is integrated into a front side of the hand-held printer.

15. The method of claim 11, further comprising displaying the image of the object on a display screen of the hand-held printer prior to capturing the image.

16. The method of claim 15, further comprising displaying a rectangle on the display screen, wherein the rectangle identifies the boundaries of the image to be captured by the digital camera scanner.

17. The method of claim 15, further comprising displaying the distance of the hand-held printer from the object.

18. The method of claim 11, further comprising projecting alignment marks onto at least one edge of the object.

19. The method of claim 18, further comprising turning off the alignment marks prior to capturing the image of the object.

20. The method of claim 11, further comprising projecting alignment marks onto at least one corner of the object.
